(19) United States
(12) Patent Application Publication
(10) Pub. No.: US 2026/0187047 A1
(43) Pub. Date: Jul. 2, 2026

(54) Method and Apparatus for Estimating Frequency Distribution From Probabilistic Data Structures

(71) Applicant: The Nielsen Company (US), LLC, New York, NY (US)

(72) Inventor: Michael Sheppard, Holland, MI (US)

(21) Appl. No.: 19/427,512

(22) Filed: Dec. 19, 2025

Related U.S. Application Data
(60) Provisional application No. 63/739,315, filed on Dec. 27, 2024.

(51) Int. Cl. G06F 16/22

(52) U.S. Cl. CPC G06F 16/2255

(57) ABSTRACT

Methods and systems for estimating the frequency table of a data set stored in a probabilistic data structure such as a counting Bloom filter or Count-Min sketch. The system observes the distribution of values in the counters of the data structure (e.g., how many counters have value 0, 1, 2, etc.) Using these observed values, the system iteratively calculates the number of unique items in the data set that appear with specific frequencies. The method accounts for hash collisions by modeling the probability that a counter value results from a single item versus multiple colliding items, allowing for the reconstruction of the item frequency distribution without querying individual elements.

### REFERENCE TO RELATED APPLICATION

This application claims priority to U.S. Provisional Patent Application No. 63/739,315, filed Dec. 27, 2024, the entirety of which is hereby incorporated by reference.

### BACKGROUND

Modern computing systems frequently manage vast datasets, such as network traffic logs, media content databases, or transaction records. A common technical challenge in these systems is managing computer memory efficiently while maintaining the ability to track data. To address memory constraints, systems often use probabilistic data structures, such as counting Bloom filters or Count-Min sketches. These data structures allow a system to track the presence or frequency of items using a compact array of counters, requiring significantly less memory than deterministic structures like hash tables or binary search trees.

To understand the operation of these structures, consider a counting Bloom filter as a fixed array of numbered buckets (counters), initially all set to zero. When a data item—such as a specific video identifier (ID) or a text string—is added to the system, it is not stored in the array. Instead, the system uses a set of mathematical rules known as hash functions to calculate a “fingerprint” for that item, with the fingerprint comprising one or more specific array indices. For example, if the system uses three hash functions, a specific item might map to index #5, index #42, and index #99. The system then increments the counters at those three specific index locations by one. If the same item appears again, the hash functions map it to the exact same indices, and those specific counters are incremented again.

A defining characteristic of these structures is that the counters are shared among all items in the dataset. As more items are added, their “fingerprints” will inevitably overlap. For instance, a second, different item might map to index #42, index #60, and index #101. In this scenario, the counter at index #42 is incremented for both the first item and the second item. Because of these “collisions,” a single counter value typically represents the cumulative frequency of multiple different items that happened to hash to that location. Consequently, looking at a single counter in isolation offers little information about any specific item; the data is entangled across the array.

### SUMMARY

Conventionally, these probabilistic data structures are designed for “point queries.” That is, they are designed to answer questions about a specific, known target element. For example, if a system administrator wants to know the frequency of a specific data packet “X,” the system hashes “X” to identify one or more specific counter indices, reads the values at those indices, and returns the minimum value as the estimated frequency of “X.” For instance, if “X” hashes to index #5, index #42, and index #99, and if index #5 has a value of 220, index #42 has a value of 317, and index #99 has a value of 273, the system would return the minimum value of 220 as an estimate of the frequency of “X”. Of course this is merely an approximation, given the likelihood of at least some collisions as noted above.

Unfortunately, a significant limitation of this conventional approach is that the system must know the identity of the item (e.g., “Packet X”) in advance, in order to query its frequency. The data structure itself is effectively opaque; one cannot simply look at the array of counters and determine which items are present or what the global distribution of frequencies looks like (e.g., a histogram). To construct a full frequency table (e.g., “How many unique items appear exactly once? How many unique items appear exactly twice? Etc.”), a conventional system would need to query every possible unique item in the universe of data, which is computationally impossible for unknown or high-cardinality data streams.

The present disclosure provides a technical solution that enables a computing system to reconstruct a global frequency table (or frequency distribution) directly from the state of the counters in a probabilistic data structure, without requiring knowledge of the specific items in the dataset.

In accordance with the disclosure, a computing system analyzes the “counter distribution”-specifically, the count of how many counters in the structure have a value of 0, how many have a value of 1, how many have a value of 2, and so forth. Using this observed metadata, the system applies a probabilistic model to “reverse engineer” the item frequencies. This method may operate sequentially: the computing system may first estimate the total number of unique items based on the number of empty counters (counters with a value of zero). It then uses this estimate to calculate how many “1-count” counters are likely the result of single items versus collisions, thereby isolating the count of unique items with a frequency of one. The system continues this iterative process—using estimates of lower-frequency items to calculate the expected “collision noise” in higher-value counters—to ultimately peel back the layers of data and construct an accurate frequency table.

This approach improves the functioning of the computer itself by enabling comprehensive data analytics (e.g., duplicate detection, traffic analysis, etc.) on massive datasets using the highly memory-efficient footprint of a Bloom filter or the like, avoiding the need for resource-heavy deterministic databases.

Accordingly, in one respect, disclosed is a method for estimating a frequency distribution of items in a data set. The method includes maintaining, in a non-transitory data storage of a computing system, a probabilistic data structure comprising a set of counters, with the values in the counters being determined by hashing items from the data set to indices associated with the counters and incrementing the counters at the associated indices based on the hashing. Further, the method includes at least one processor of the computing system establishing a counter distribution of the set of counters, the counter distribution indicating, respectively for each of a plurality of integer values ranging from zero to a maximum value, a count of counters having the integer value. In addition, the method includes the at least one processor estimating a total number of unique items in the data set, based on the count that the established counter distribution indicates for counters that have the integer value of zero. And the method includes the at least one processor generating a frequency table for the data set by iteratively calculating a number of unique items associated with a target frequency k (nₖ), including (i) identifying, from the established counter distribution, the count of counters that have the value k and (ii) adjusting the identified count to remove a calculated probability of hash collisions derived from one or more previously estimated numbers of unique items associated with frequencies lower than k.

In another respect, disclosed is a method for constructing a frequency table for items in a data set. The method includes accessing a probabilistic data structure comprising an array of counters representing a set of unique items. Further, the method includes determining an observed counter distribution that indicates, respectively for each of a plurality of integer count values, a quantity of counters in the array associated with the integer count value. Still further, the method includes estimating a total cardinality of unique items in the probabilistic data structure based on a quantity of empty counters indicated by the observed counter distribution. And the method includes constructing a frequency table for the unique items by sequentially solving for a number of unique items having a frequency k, where solving for the number of unique items having the frequency k depends on (i) a quantity of counters in the array that have the value k and (ii) previously solved numbers of unique items having frequencies less than k.

In yet another respect, disclosed is a method of estimating a count of unique data items in a data set that have a frequency of occurrence of value k. The method includes maintaining a set of counters having values determined by hashing the data items of the data set. Further, the method includes identifying, from the set of counters, a number of counters, mₖ, that have the integer value k. Yet further, the method includes estimating a count of unique data items in the data set, nₖ, that have a frequency of occurrence equal to k, where estimating nₖ includes differentiating between counters having the value k due to a single data item appearing k times and counters having the value k due to a collision of multiple data items appearing fewer than k times, and where the differentiating is based on previously estimated counts of unique data items having frequencies of occurrence less than k.

In still another respect, disclosed is a computing system including at least one processor, at least one non-transitory computer-readable medium, and program instructions stored in the at least one non-transitory computer-readable medium and executable by the at least one processor to cause the computing system to carry out any of the disclosed methods.

Further, in another respect, disclosed is at least one non-transitory computer-readable medium having stored thereon program instructions executable by at least one processor of a computing system to cause the computing system to carry out any of the disclosed methods.

The present disclosure also contemplates a computer program product executable by at least one processor of a computing system to cause the computing system to carry out any of the disclosed methods.

These, as well as other aspects, advantages, and alternatives, will become apparent to those of ordinary skill in the art by reading the following detailed description, with reference where appropriate to the accompanying drawings. Further, it should be understood that the disclosure provided in this summary elsewhere in this document is provided by way of example only and that numerous variations and other examples may be possible as well.

### BRIEF DESCRIPTION OF THE DRAWINGS

FIG. 1 is a simplified block diagram of an example content system.

FIG. 2 is a simplified block diagram of an example computing system.

FIG. 3 is a simplified diagram illustrating an array of counters in a probabilistic data structure.

FIG. 4 is a flow chart illustrating for estimating a frequency table based on counters in a counting Bloom filter for instance.

FIG. 5 is a flow chart illustrating an example iterative peeling-back process for generation of the frequency table.

FIG. 6 is a flow chart illustrating a method for estimating a frequency distribution of items in a data set.

FIG. 7 is a flow chart illustrating a method for constructing a frequency table for items in a data set.

FIG. 8 is a flow chart illustrating a method of estimating a count of unique data items in a data set that have a frequency of occurrence of value k.

### DETAILED DESCRIPTION

### 1. Definitions and Overview

In this disclosure, the term “counter distribution” refers to the observed statistical state of the data structure's memory array, indicating a count of how many counters in the array have a specific integer value (e.g., “15,000 counters have a value of 0”; “4,000 counters have a value of 1”; etc.) Further, the term “frequency table” refers to the estimated global statistics of the actual data items, indicating a count of unique items associated with a specific frequency of occurrence (e.g., “30,000 unique items appear exactly once”; “5,000 unique items appear exactly twice; etc.)

As noted above, conventional usage of counting Bloom filters requires querying a known key. If a system stores data for “Item A” (hashed to counters at index 5 and 9) and “Item B” (hashed to counters at index 9 and 12), the counter at index 9 will effectively store the sum of counts for Item A and Item B. If a user queries “Item A,” the system checks indices 5 and 9, the system sees the collision at index 9, and the system effectively “filters” out that collision by taking the minimum value (the value at index 5). However, without the key “Item A,” the system sees only a set of numbers and cannot distinguish signal from noise. The present arrangement helps to solve that problem by having the system use the distribution of the numbers themselves.

### 2. Example Architecture

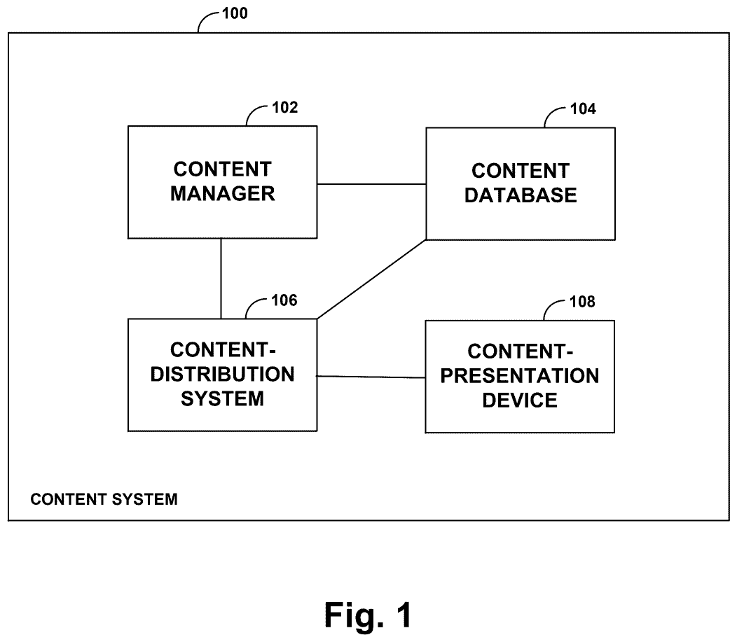

FIG. 1 is a simplified block diagram of an example content system 100 in which the disclosed techniques may be implemented. The content system 100 serves as an example operational environment for managing large-scale data. As shown, the content system 100 includes a content manager 102, a content database 104, a content-distribution system 106, and a content-presentation device 108, which may be communicatively coupled via various connection mechanisms (e.g., the Internet, local area networks, or system buses).

In this example arrangement, the content database 104 is configured to store vast amounts of media content, which may include video content (e.g., movies, television shows, etc.), audio content, or associated metadata. In large-scale implementations, this database may contain millions of unique items, making efficient data management critical.

The content manager 102 acts as a central controller for organizing, indexing, and maintaining the data within the content database 104. In example implementations, it is within this component that the technical challenges of data scale arise. For example, to prevent storage waste, the content manager 102 may need to detect duplicate entries or analyze the frequency of specific data tags across the entire database. To perform these tasks without consuming excessive memory and processing power, the content manager 102 may make use of the probabilistic data structures (e.g., counting Bloom filters) described herein. In particular, instead of loading the full dataset into active memory and seeking to analyze that data set, the content manager 102 may more efficiently maintain a compact array of counters representing the data. The content manager 102 may then be configured to execute the present frequency-estimation algorithms to extract analytics (e.g., a frequency table) from these compact structures.

The content-distribution system 106 and content-presentation device 108 (e.g., a user's laptop, television, or mobile device) represent example downstream consumers of the content. While the presently disclosed operations may be carried primarily within the data management layer (e.g., Manager 102 and Database 104), efficient frequency estimation usefully improves the overall system performance, for example, by allowing the distribution system 106 to quickly identify and cache frequently requested content items based on the frequency tables generated by the content manager 102.

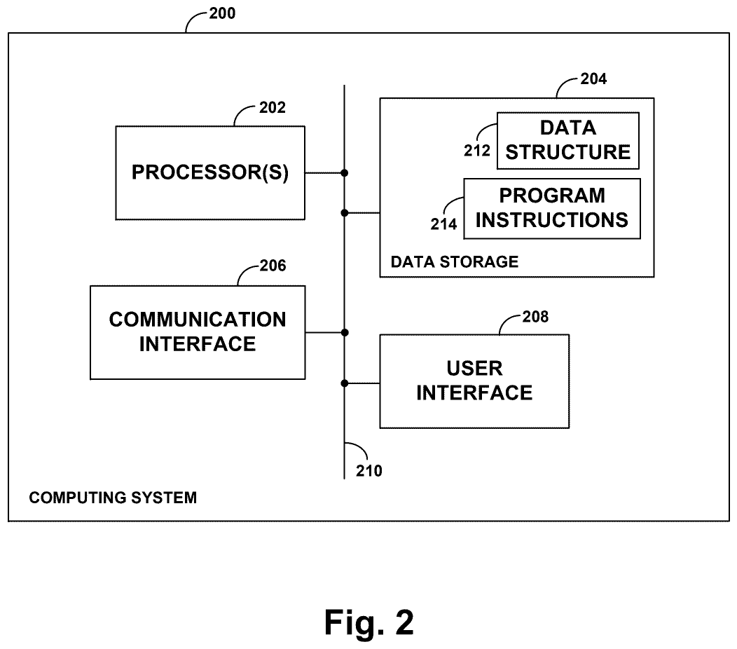

FIG. 2 is next a simplified block diagram of an example computing system 200. This figure illustrates the physical hardware architecture that may be used to implement the content manager 102 or other components of the content system 100. The computing system 200 includes at least one processor 202, at least one non-transitory computer-readable data storage medium 204, a communication interface 206, and a user interface 208, which may be integrated with each other and/or communicatively linked by a system bus, a network, and/or one or more other connection mechanisms 210.

The processor(s) 202 may comprise may include one or more general purpose processors (e.g., microprocessors) and/or one or more specialized processors (e.g., digital signal processors (DSPs), graphics processing units (GPUs), neural processing units (NPUs), etc.) For present purposes, the processor(s) 202 can be the hardware entity that executes the mathematical operations required to “reverse engineer” the frequency table. This may include performing hash functions on data items, incrementing counters in memory, determining the distribution of counter values (e.g., counting how many “zeros” exist etc.), and solving the iterative equations to calculate the estimated item frequencies (n₁, n₂, etc.)

The non-transitory data storage 204 may include one or more volatile and/or non-volatile storage components (e.g., flash, optical, magnetic, read only memory (ROM), random access memory (RAM) (e.g., dynamic RAM (DRAM), static RAM (SRAM), or double data rate RAM (DDRAM)), electronically programmable read only memory (EPROM), and/or electronically erasable programmable read only memory (EEPROM), etc.), which may be integrated in whole or in part with the processor(s) 202 or may be provided separately.

For present purposes, the data storage 204 may physically store a data structure 212 and program instructions 214. The data structure 212 may be an array of counters (e.g., the counting Bloom filter or Count-Min Sketch). Through interaction with this data structure, the processor(s) 202 may effectively track potentially millions of items using a relatively small, fixed amount of physical memory. The program instructions 214 may then comprise logic such as software and/or firmware that, when executed by the processor(s) 202, cause the system to perform operations such as the present estimation method for instance.

The communication interface 206 enables the computing system 200 to ingest the stream of data items (e.g., to receive new media files or data packets) from external sources. For instance, through the communication interface 206, the processor(s) 202 may ingest new data items (e.g., media segments, packet headers, database keys, etc.), hashing the items and accordingly updating the counters in the data structure.

Further, the user interface 208 (e.g., a display, keyboard, or mouse) allows a system administrator to initiate the analysis or view the resulting frequency table, perhaps in the form of a histogram presented on a display screen, among other possibilities.

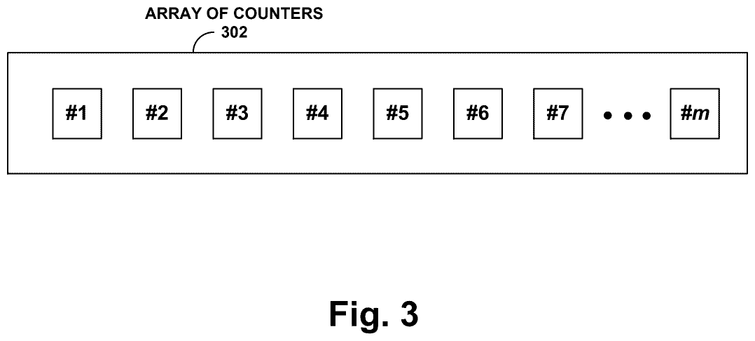

FIG. 3 illustrates example context for the present operations. In particular FIG. 3 depicts an example data structure as an array of m counters 302 that the processor(s) 202 may establish and maintain in the data storage 204, based on hashing of the data items and accordingly updating of counters for the associated indexes.

### 3. Example Operations

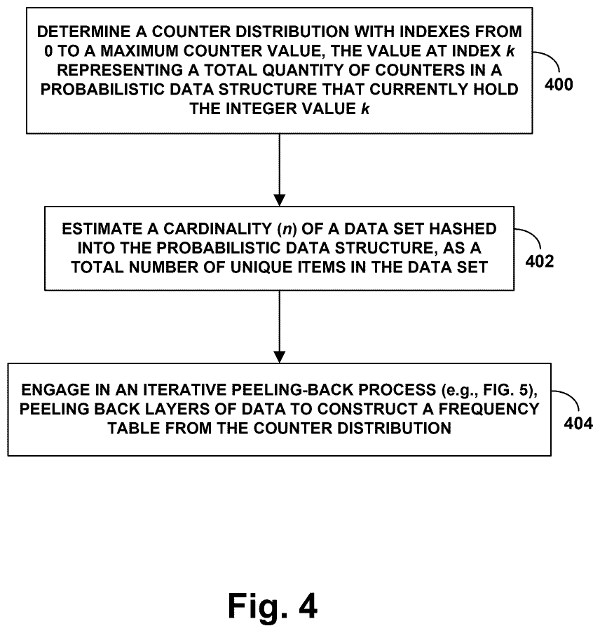

FIG. 4 is a flow chart illustrating an example method for estimating a frequency table based on these or other such counters. This example method can be carried out by a computing system such as that described above, among other possibilities.

As shown in FIG. 4, at block 400, the example method involves determining a counter distribution. To do this in an example implementation, the computing system scans the array of m counters and generates a counter distribution vector (or array) {m₀, m₁, m₂, . . . , mₘₐₓ} stored in the data storage 204.

In this content distribution vector, the value at index k represents the total quantity of counters in the probabilistic data structure that currently hold the integer value k. While the raw counting Bloom filter has a length of m (e.g., 100,000), this distribution has a length determined by the maximum value observed in any counter (e.g., 15). However, the sum of the values within this distribution vector equals m. To understand why this sum of content-distribution-vector values equals m, consider a tiny counting Bloom filter with m=5 counters, where each item is hashed to two indices. With that example, if the counting Bloom filter array is {1, 2, 1, 0, 0} (which represents a situation where index 1 experienced a collision and now has a count of 2), that means that m₀ (the number of instances of count value 0, i.e., empty) is 2, m₁ (the number of instances of count value 1) is 2 (from indexes 0 and 2), and m₂ (the number of instances of count value 2) is 1 (from index 1). The sum of those numbers is thus 2+2+1, which equals the length of m=5 of the counting Bloom filter.

At block 402, the example method then involves estimating a cardinality (n) of the data set hashed into the probabilistic data structure, namely, a total number of unique items in the data set. To do so in an example implementation, the computing system relies on the premise that the number of empty counters (m₀) is not random but is rather mathematically related to the total volume of data inserted.

To understand this, consider the counters as “bins” and the hash operations as “balls” thrown into those bins. If a system throws a small number of balls into a large number of bins, many bins will remain empty. As the number of balls thrown increases, the number of empty bins decreases at a specific, predictable rate defined by probability theory.

In the context of a counting Bloom filter, each unique item is hashed h times, effectively “throwing” h balls at the array of m counters. Because hash functions are generally statistically uniform, the probability of any specific ball missing a specific counter is (1−1/m). For a counter to remain completely empty (i.e., having a value of 0) after n items are added, it must have been “missed” by every single hash operation (h×n total hashes). Therefore, the probability of a counter being zero is (1−1/m)^{hn}.

In the example implementation, the system observes the actual proportion of empty counters (m₀/m) in the physical counting Bloom filter array and equates this observed ratio to the theoretical probability. By solving this equation for n, the system can accurately estimate the total number of unique items in the dataset without needing to count them individually.

In the example implementation, the system observes the actual proportion of empty counters (m₀/m) in the physical counting Bloom filter array and equates this observed ratio to the theoretical probability derived above. Specifically, the system uses the following equality:

$$\frac{{m}_{0}}{m} = {( 1 - \frac{1}{m} )}^{hn}$$

where m is the known array size, h is the known number of hash functions, and n is the unknown variable representing the total number of unique items. To solve for n, the system may perform an algebraic inversion of this equality. By taking the logarithm of both sides, the exponent (hn) can be isolated. The system then divides by the hash count (h) and the logarithmic probability factor to yield an estimate of n as follows:

$$n = ( \frac{1}{h} ) ( \frac{log ( \frac{{m}_{0}}{m} )}{log ( 1 - \frac{1}{m} )} )$$

This process allows the processor to accurately estimate the total number of unique items (n) in the dataset using only the count of empty bins, without needing to access or count the items individually.

At block 404, the example method then involves engaging in an iterative peeling-back process as noted above, namely, peeling back the layers of data and constructing a frequency table. Here, the computing system engages in processing to determine a frequency table (n₁ n₂, n₃, . . . ) from the counter distribution (m₁, m₂, m₃, . . . ). In particular, at this step, (i) the system knows mₖ, which is the number of counters with value k, and (ii) the system wants to know nₖ, which is the number of items with frequency k, i.e., the number of unique items that appear exactly k times.

A primary technical challenge in this process is that the counters in the data structure are “blind” accumulators; they store a running total sum without recording the identity of the items that contributed to that sum. Consequently, the observed value of a counter is often ambiguous.

For example, the system cannot simply assume that a counter with a value of 2 represents a unique item that appeared twice. In a shared probabilistic structure, a counter might read “2” in either of two distinct, competing scenarios that look identical to the observer. In Scenario A (True Signal), a single unique item actually appeared twice in the data stream (frequency=2) and hashed to this counter index. This is the specific data point (n₂) that the system seeks to identify. In Scenario B (Collision Noise), on the other hand, two different items, each of which appeared only once in the data stream (frequency=1), happened to map to this exact same counter index due to a hash collision. Because the counter simply adds the two separate increments (1+1=2), this “noise” mimics the signal of Scenario A. Namely, to the system reading the integer “2”, Scenario B is indistinguishable from Scenario A.

To accurately estimate the unknown quantity of true Scenario A items (n₂), the system can mathematically “clean” the observed data. In particular, the system can calculate the probabilistic likelihood of Scenario B occurring (i.e., the likelihood of single-occurrence items colliding) and can subtract that calculated “collision noise” from the total number of counters reading “2.” However, the system cannot calculate the probability of Scenario B unless it first knows how many single-occurrence items (n₁) exist in the dataset to begin with. This dependency forces the system to solve the problem sequentially, starting from the lowest frequency and working upward-effectively “peeling back” layers of collision noise one by one to reveal the true signals underneath.

As an example implementation of this process, the system may begin by estimating the number of items that appear exactly once (n₁). To do so, the system may analyze the counters that have a value of 1 (m₁). This count is the least ambiguous, because a value of 1 cannot be formed by a collision of multiple items (as any collision of two or more items would necessarily results in a value of at least 2). A value of 1 can only occur if exactly one item hashed to that counter and no other items collided with it.

While the source of a counter reading “1” is unambiguous (it must be a single item), the quantity of such counters (m₁) does not directly equal the total number of unique items that appeared once (n₁). This is because the count m₁ represents only the “survivors”—the subset of n₁ items that were lucky enough to land in an empty counter and not be hit by any subsequent hash operations. Many other items that appeared exactly once (n₁) may have been “covered up” by collisions. For example, if an item with frequency 1 hashes to index #5, and a different item also hashes to index #5, then the counter value of index #5 becomes 2. The original “1” is effectively overwritten and hidden inside the higher value. Consequently, the observed count m₁ is always smaller than the true unknown quantity n₁.

To recover the true value of n₁, the system performs a “reverse calculation” using the total item count (n) estimated at block 402. Because the system knows the total number of items (n) and the size of the array (m), the system can calculate the precise “crowding” of the filter. This allows the system to determine a specific “survival ratio”—for example, calculating that, given the current crowd, only 60% of single-occurrence items will remain alone in a counter, while the other 40% will inevitably collide and be merged into higher values. The system then applies this ratio to the observed data. For instance, if the system 600 observes counters with a value of “1” (m₁), and it knows the survival ratio is 60%, it can then divide the observed count by the ratio (600/0.60) to reveal that exactly 1,000 unique items (n₁) must have existed originally.

By scaling up the observed “survivors” (m₁) based on the calculated probability of collision, the system mathematically restores the items that were lost to collisions. Mathematically, the computing system may calculate this estimated number of unique items with frequency one (n₁) using the following relationship derived from the counter distribution:

$${n}_{1} = \frac{( m - 1 ) {m}_{1}}{h \cdot {m}_{0}}$$

where m is the array size, m₁ is the count of counters with value 1, m₀ is the count of empty counters, and h is the number of hash functions. This calculation provides the precise baseline that can be used for the iterative peeling-back process.

With n₁ established, the system proceeds to the next frequency tier (k=2) to solve for n₂. The system analyzes the count of counters holding the integer value 2 (m₂). The system differentiates between the two statistical sources of this value: (i) the “signal,” representing single unique items with a frequency of 2 that hashed to the index without interference, and (ii) the “noise,” representing a collision of two distinct items from the previously identified n₁ population (i.e., a “1+1” collision). Because n₁ is now a known quantity, the system calculates the probabilistic expected count of these “1+1” collisions and subtracts this count from the observed m₂. The remaining value represents the observed survivors of the n₂ population. Finally, just as it did for n₁, the system scales this remaining value by the survival probability to account for true n₂ items that were “covered up” by higher-order collisions (e.g., an n₂ item colliding with an n₁ item to form a counter value of 3), thereby yielding the estimated total for n₂

Accordingly, after the system determines the total item count (n), the system enters an iterative processing loop at block 404 to construct the frequency table element-by-element. Because the value of a higher-frequency counter (e.g., value 5) is composed of “signal” (items with frequency 5) and “noise” (collisions from items with frequencies 1, 2, 3, and 4), the system solves for the frequencies sequentially, starting from 1 and working upward.

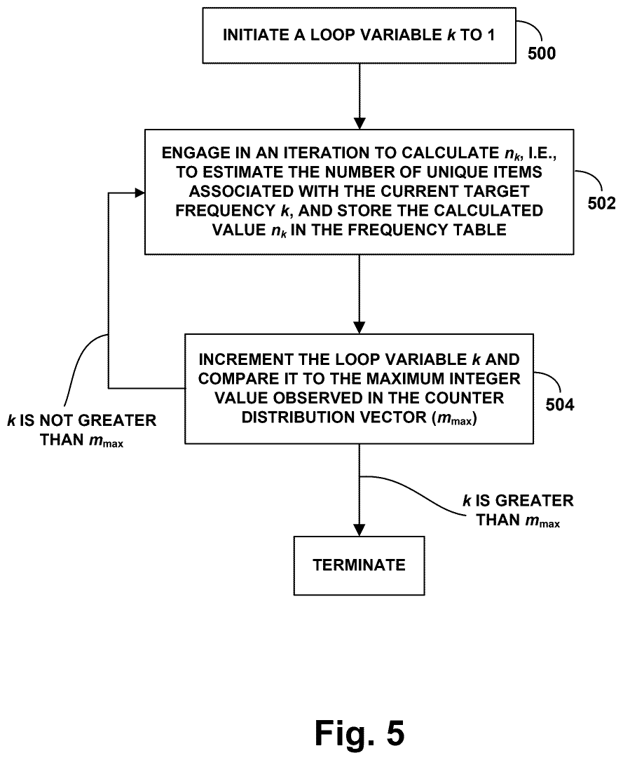

FIG. 5 illustrates an example of this iterative peeling-back process and generation of the frequency table more specifically.

As shown in FIG. 5, at block 500, the system starts by initiating a loop variable k to 1. At block 502, the system then engages in an iteration of the process, to calculate nₖ, i.e., to estimate the number of unique items associated with the current target frequency k. To do this, the system accesses the counter distribution vector to identify the observed quantity of counters having the value k (mₖ). The system then adjusts this observed quantity by removing the probability of hash collisions. This adjustment is derived from “knowns” established in previous steps.

In some example implementations, the processor calculates these collision probabilities by utilizing a generating function. In this context, a generating function is a formal power series in which the coefficients of the series encode a sequence of numbers-specifically, the probability distributions of the counter values. By modeling the hash collisions as operations on these polynomials (representing integer partitions of the counter values), the system can encapsulate the complex combinatorial probabilities of multiple items colliding into a single compact function (e.g., H(x)). The coefficients of this generating function correspond to the expected counter distribution values, which the system then equates to the actually observed counter distribution values (e.g., mₖ_{₁} or a normalized version of mₖ) to algebraically solve for the unknown item frequencies (nₖ). This approach can allow the system to handle the full combinatorial complexity of the “peeling back” process without requiring computationally expensive brute-force enumeration of every possible collision scenario.

In the first iteration (k=1), the system uses the total cardinality (n) determined at block 402 to calculate the baseline probability that a single item would “survive” in a counter alone. And it applies this rate to m₁ to solve for n₁. In subsequent iterations (k>1), the system calculates the probability that items from lower frequency tiers (previously solved values n₁ through nₖ₋₁) collided to form the current value k, and the system subtracts this cumulative collision noise from mₖ to isolate the true value of nₖ.

In each iteration of block 502, once the system has calculated the value for nₖ, the system stores that value in the frequency table. This stored frequency value immediately becomes a known input available for the calculation of the next frequency tier.

At block 504, the system then increments the loop variable k and compares it to the maximum integer value observed in the counter distribution vector (mₘₐₓ). If k has not yet exceeded mₘₐₓ, then the system returns to block 502 to process the next frequency iteration. This loop thus terminates once the system has successfully calculated the item frequency for the maximum observed counter value, at which point the frequency table is complete.

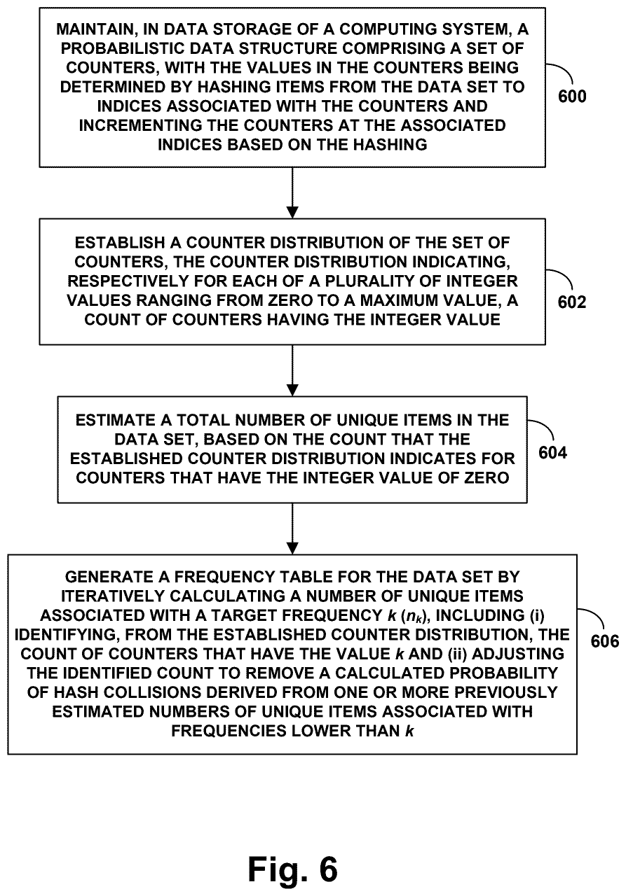

FIG. 6 is a flow chart illustrating a method for estimating a frequency distribution of items in a data set.

A shown in FIG. 6, at block 600, the method includes maintaining, in a non-transitory data storage of a computing system, a probabilistic data structure comprising a set of counters, with the values in the counters being determined by hashing items from the data set to indices associated with the counters and incrementing the counters at the associated indices based on the hashing. Further, at block 602, the method includes at least one processor of the computing system establishing a counter distribution of the set of counters, the counter distribution indicating, respectively for each of a plurality of integer values ranging from zero to a maximum value, a count of counters having the integer value.

At block 604, the method additionally includes the at least one processor estimating a total number of unique items in the data set, based on the count that the established counter distribution indicates for counters that have the integer value of zero. And at block 606, the method includes the at least one processor generating a frequency table for the data set by iteratively calculating a number of unique items associated with a target frequency k (nₖ), including (i) identifying, from the established counter distribution, the count of counters that have the value k and (ii) adjusting the identified count to remove a calculated probability of hash collisions derived from one or more previously estimated numbers of unique items associated with frequencies lower than k.

In line with the discussion above by way of example, the probabilistic data structure in this method can be a counting Bloom filter or a Count-Min sketch. While the detailed examples provided herein primarily describe operations on a counting Bloom filter (e.g., single array, multiple hashes), the disclosed methodology is equally applicable to a Count-Min sketch data structure. As understood by those skilled in the art, a Count-Min sketch typically utilizes multiple independent arrays (rows), each associated with a distinct hash function. To adapt the present method for a Count-Min sketch, the at least one processor can determine the counter distribution value mₖ by calculating the average number of counters having value k across the multiple rows. Further, because the rows in a Count-Min sketch effectively operate as independent estimators, the variable h (number of hash functions) in the collision probability formulas derived above can be set to 1 (h=1). By substituting these values (average distribution counts and h=1), the at least one processor can effectively use the Law of Large Numbers to refine the frequency estimates.

Further, as discussed above by way of example, the act of iteratively calculating the number of unique items associated with the target frequency k (nₖ) can involve (a) calculating a number of unique items having a frequency of one (n₁) based on the count of counters that have a value of one and the estimated total number of unique items and (b) then calculating a number of unique items having a frequency of two (n₂) based on the count of counters having a value of two and the calculated number of unique items having a frequency of one (n₁).

Still further, as discussed above by way of example, the calculated probability of hash collisions can represent a likelihood that a plurality of unique items having frequencies lower than k hashed to a same counter index to sum a counter of the counter index to the value k. And the act of generating the frequency table can involve equating an expected value of counters having value k to an observed number of counters having value k, wherein the expected value is defined by a generating function representing collision probabilities.

Usefully, this method allows the computing system to generate the frequency table without a need for the computing system to query the probabilistic data structure using specific item identifiers, which thereby significantly improves processing efficiency.

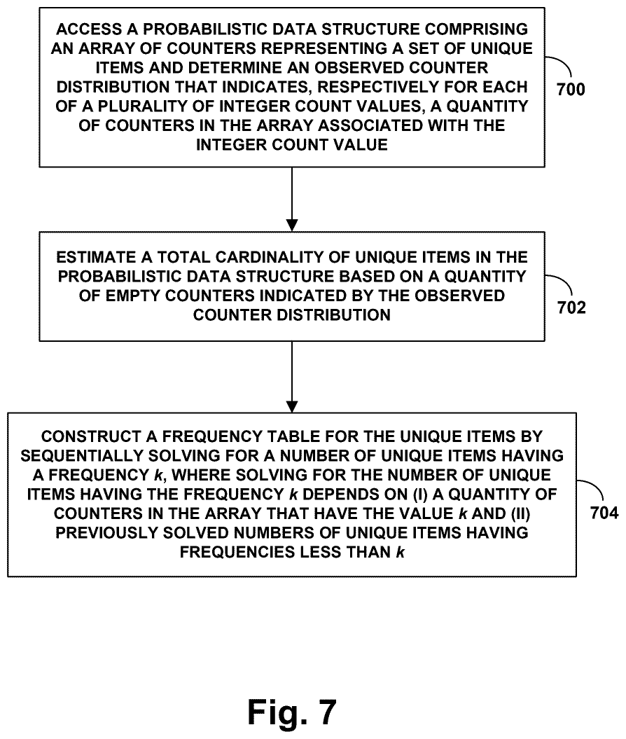

FIG. 7 is next a flow chart illustrating a method for constructing a frequency table for items in a data set.

As shown in FIG. 7, at block 700, the method includes accessing a probabilistic data structure comprising an array of counters representing a set of unique items and determining an observed counter distribution that indicates, respectively for each of a plurality of integer count values, a quantity of counters in the array associated with the integer count value. Still further, at block 702, the method includes estimating a total cardinality of unique items in the probabilistic data structure based on a quantity of empty counters indicated by the observed counter distribution. And at block 704, the method includes constructing a frequency table for the unique items by sequentially solving for a number of unique items having a frequency k, where solving for the number of unique items having the frequency k depends on (i) a quantity of counters in the array that have the value k and (ii) previously solved numbers of unique items having frequencies less than k.

Various other features discussed herein can be implemented in this context as well, and vice versa.

For instance, the probabilistic data structure in this method can be a counting Bloom filter or a Count-Min sketch, among other possibilities. For instance, the probabilistic data structure can be a counting Bloom filter, wherein the counting Bloom filter uses h hash functions, and wherein estimating the total cardinality is based on a probability (1−1/m)^{hn}, wherein m is a size of the array and n is the estimated total cardinality. Further, the act of solving for the number of unique items having the frequency k can involve (a) modeling a probability of hash collisions capable of producing a counter value of k, with the modeling using the previously solved numbers of unique items, and (b) subtracting the modeled probability from the observed counter distribution. Yet further, the act of constructing the frequency table can involve equating an expected value of counters having value k to an observed number of counters having value k, with the expected value being defined by a generating function representing collision probabilities. Still further, this method can allow the computing system to construct the frequency table without querying the probabilistic data structure using specific item identifiers.

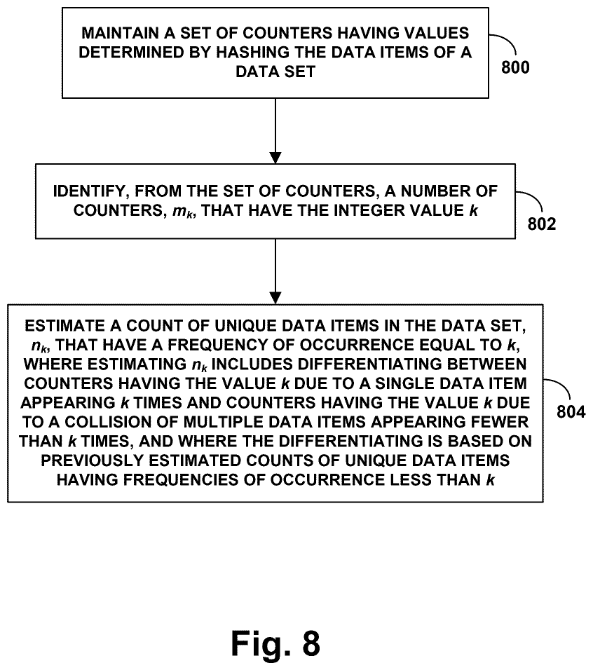

FIG. 8 is a flow chart illustrating a method of estimating a count of unique data items in a data set that have a frequency of occurrence of value k. As shown in FIG. 8, at block 800, the method includes maintaining a set of counters having values determined by hashing the data items of the data set. Further, at block 802, the method includes identifying, from the set of counters, a number of counters, mₖ, that have the integer value k. Yet further, at block 804, the method includes estimating a count of unique data items in the data set, nₖ, that have a frequency of occurrence equal to k, where estimating nₖ includes differentiating between counters having the value k due to a single data item appearing k times and counters having the value k due to a collision of multiple data items appearing fewer than k times, and where the differentiating is based on previously estimated counts of unique data items having frequencies of occurrence less than k.

Various other features discussed herein can be implemented in this context as well, and vice versa.

For instance, the act of maintaining the set of counters can involve maintaining a counting Bloom filter defining the set of counters and/or maintaining a Count-Min sketch defining the set of counters, among other possibilities. Further, the act of estimating nₖ can be performed sequentially starting from k=1. Still further, the method can also include constructing a frequency table including the estimated count of unique data items, nₖ, that have the frequency of occurrence equal to k. And the method can also include using the estimated count of unique data items, nₖ, to perform duplicate detection or traffic analysis on the data items, among other practical actions.

As a specific example of such traffic analysis, the disclosed system may be implemented within a network security device, such as a router or firewall, to facilitate Distributed Denial of Service (DDoS) detection. In this scenario, the data items may comprise source Internet Protocol (IP) addresses of incoming packets. A router with limited memory cannot store a standard counter for every possible IP address (e.g., the vast IPV6 address space). However, by using the disclosed method, the router can maintain a compact probabilistic structure (e.g., a counting Bloom filter or Count-Min sketch) of the traffic. Periodically, the processor can reconstruct the global frequency distribution of the traffic to identify the count of “heavy hitters” (IP addresses sending an abnormally high frequency of packets) without needing to know the specific IP addresses in advance. If the reconstructed distribution shows a statistical anomaly—such as a sudden spike in the number of items having a frequency greater than a threshold (e.g., >10,000)—the system can then automatically trigger a mitigation protocol or switch to a high-precision logging mode. This allows for real-time security analysis on high-speed network links where traditional deterministic logging is too slow or memory-intensive.

Numerous other practical applications are possible as well. By way of example, another practical application would be to optimize database query execution. Relational database management systems (DBMS) often rely on data histograms to estimate the “selectivity” of a query (e.g., estimating how many rows will match a command like “SELECT*WHERE value=X”). Storing exact histograms for every column in a massive database table is often memory-prohibitive. Instead, the database system may maintain a Counting Bloom Filter for the column data. When generating a query plan, the database query optimizer may then use the disclosed method to regenerate the approximate frequency distribution of the data values from the filter. This may thereby allow the optimizer to accurately predict the result size of query operations and intelligently choose between execution strategies (e.g., choosing a “Sequential Scan” for large result sets versus an “Index Scan” for small result sets), thereby helping to reduce processor load and query latency.

In yet another practical application, the disclosed techniques may be employed within the content manager 102 or content-distribution system 106 to optimize media caching and storage tiering. In this context, the data items hashed into the probabilistic data structure may comprise unique identifiers for media assets (e.g., video IDs, song titles, or file chunk hashes) requested by users, among other possibilities. Maintaining a deterministic counter for every asset in a massive catalog can be prohibitively expensive in terms of memory and write-throughput. By using the disclosed frequency estimation method, the computing system can instead reconstruct the global popularity distribution of the media catalog directly from the compact filter. This allows the system to identify specific frequency thresholds that define “trending” or “viral” content. Based on this reconstructed table, the system can automatically modify the storage state of the media items—for instance, by proactively moving items identified as high-frequency from high-latency cold storage (e.g., a central magnetic disk array) to low-latency edge caches (e.g., solid-state drives or RAM at network edges). This ensures that the most popular content is served with minimal latency, improving the functioning of the content delivery network while minimizing the memory footprint required to track popularity metrics.

### 4. Technical Advantages

The disclosed methodology provides specific improvements to the functioning of a computer. By enabling global analytics on a Bloom filter, the system avoids the need to store full item identifiers (e.g., storing the full text of “Hamlet”), thereby reducing memory usage by orders of magnitude. Furthermore, it enables the extraction of a frequency histogram in time linear to the size of the filter (O (m), rather than linear to the size of the universe of keys, effectively reducing processing latency for large-scale data analysis.

What is claimed is:

1. A method for estimating a frequency distribution of items in a data set, the method comprising:
maintaining, in a non-transitory data storage of a computing system, a probabilistic data structure comprising a set of counters, wherein values in the counters are determined by hashing items from the data set to indices associated with the counters and incrementing the counters at the associated indices based on the hashing;
establishing, by at least one processor of the computing system, a counter distribution of the set of counters, the counter distribution indicating, respectively for each of a plurality of integer values ranging from zero to a maximum value, a count of counters having the integer value;
estimating, by the at least one processor, a total number of unique items in the data set, based on the count that the established counter distribution indicates for counters that have the integer value of zero; and
generating, by the at least one processor, a frequency table for the data set by iteratively calculating a number of unique items associated with a target frequency k (nₖ), including (i) identifying, from the established counter distribution, the count of counters that have the value k and (ii) adjusting the identified count to remove a calculated probability of hash collisions derived from one or more previously estimated numbers of unique items associated with frequencies lower than k.

2. The method of claim 1, wherein the probabilistic data structure is a counting Bloom filter.

3. The method of claim 1, wherein the probabilistic data structure is a Count-Min sketch.

4. The method of claim 1, wherein iteratively calculating the number of unique items associated with the target frequency k (nₖ) comprises:
calculating a number of unique items having a frequency of one (n₁) based on the count of counters that have a value of one and the estimated total number of unique items; and
then calculating a number of unique items having a frequency of two (n₂) based on the count of counters having a value of two and the calculated number of unique items having a frequency of one (n₁).

5. The method of claim 1, wherein the calculated probability of hash collisions represents a likelihood that a plurality of unique items having frequencies lower than k hashed to a same counter index to sum a counter of the counter index to the value k.

6. The method of claim 1, wherein generating the frequency table comprises equating an expected value of counters having value k to an observed number of counters having value k, wherein the expected value is defined by a generating function representing collision probabilities.

7. The method of claim 1, wherein the method allows the computing system to generate the frequency table without querying the probabilistic data structure using specific item identifiers.

8. A computing system comprising:
at least one processor; and
at least one non-transitory computer-readable medium storing instructions executable by the at least one processor to cause the computing system to carry out operations including:
accessing a probabilistic data structure comprising an array of counters representing a set of unique items,
determining an observed counter distribution indicating, respectively for each of a plurality of integer count values, a quantity of counters in the array associated with the integer count value,
estimating a total cardinality of unique items in the probabilistic data structure based on a quantity of empty counters indicated by the observed counter distribution, and
constructing a frequency table for the unique items by sequentially solving for a number of unique items having a frequency k, wherein solving for the number of unique items having the frequency k depends on (i) a quantity of counters in the array that have the value k and (ii) previously solved numbers of unique items having frequencies less than k.

9. The computing system of claim 8, wherein the probabilistic data structure is a counting Bloom filter.

10. The computing system of claim 8, wherein the probabilistic data structure is a Count-Min sketch.

11. The computing system of claim 8, wherein solving for the number of unique items having the frequency k comprises:
modeling a probability of hash collisions capable of producing a counter value of k, wherein the modeling uses the previously solved numbers of unique items; and
subtracting the modeled probability from the observed counter distribution.

12. The computing system of claim 8, wherein the probabilistic data structure is a counting Bloom filter, wherein the counting Bloom filter uses h hash functions, and wherein estimating the total cardinality is based on a probability (1−1/m)^{hn}, wherein m is a size of the array and n is the estimated total cardinality.

13. The computing system of claim 8, wherein constructing the frequency table comprises equating an expected value of counters having value k to an observed number of counters having value k, wherein the expected value is defined by a generating function representing collision probabilities.

14. The computing system of claim 8, wherein the operations allow the computing system to construct the frequency table without querying the probabilistic data structure using specific item identifiers.

15. At least one non-transitory computer-readable medium having stored thereon program instructions executable by at least one processor of a computing system to cause the computing system to carry out operations comprising:
maintaining a set of counters having values determined by hashing data items;
identifying, from the set of counters, a number of counters, mₖ, that have a specific integer value k;
estimating a count of unique data items, nₖ, that have a frequency of occurrence equal to k,
wherein estimating nₖ comprises differentiating between counters having the value k due to a single data item appearing k times and counters having the value k due to a collision of multiple data items appearing fewer than k times, and
wherein the differentiating is based on previously estimated counts of unique data items having frequencies of occurrence less than k.

16. The at least one non-transitory computer-readable medium of claim 15, wherein maintaining the set of counters comprises maintaining a counting Bloom filter defining the set of counters.

17. The at least one non-transitory computer-readable medium of claim 15, wherein maintaining the set of counters comprises maintaining a Count-Min sketch defining the set of counters.

18. The at least one non-transitory computer-readable medium of claim 15, wherein estimating nₖ is performed sequentially starting from k=1.

19. The at least one non-transitory computer-readable medium of claim 15, wherein the operations further include constructing a frequency table including the estimated count of unique data items, nₖ, that have the frequency of occurrence equal to k.

20. The at least one non-transitory computer-readable medium of claim 15, wherein the operations further comprise using the estimated count of unique data items, nₖ, to perform duplicate detection or traffic analysis on the data items.
